(19) United States
(12) Patent Application Publication
(10) Pub. No.: US 2004/0166902 A1
(43) Pub. Date: Aug. 26, 2004

(54) Method and system for reducing cell interference using advanced antenna radiation pattern control

(76) Inventors: Dan Castellano, Sunnyvale, CA (US); Kenneth Kludt, San Jose, CA (US)

Correspondence Address: SVComm, Inc., Attn: Bob Selby or Dan Castellano, 928 Olive Ave., Sunnyvale, CA, 94086, US

(21) Appl. No.: 10/750,613

(22) Filed: Jan. 2, 2004

Related U.S. Application Data
(60) Provisional application No. 60/440,956, filed on Jan. 21, 2003.

(51) Int. Cl. H04B 1/38

(52) U.S. Cl. 455/562.1; 455/73

(57) ABSTRACT

An antenna tower generates two or more radiation patterns and selects the best pattern for receiving communications from a subscriber based on signal strength and/or signal quality. The antenna tower uses the radiation pattern selected for receiving the communications from the subscriber for conducting communications to the subscriber.

### RELATED APPLICATIONS

None

### TECHNICAL FIELD OF THE INVENTION

This invention relates generally to the field of communications systems and more specifically to a method and system for reducing interference using special and unique basestation antenna radiation patterns.

### BACKGROUND OF THE INVENTION

The rising use of communications systems has led to the increasing demand for more effective and efficient techniques for communicating signals. An antenna tower located in a cell site communicates a signal to a subscriber in the cell site. Signals from other antenna towers, however, may interfere with the communicated signal, resulting in degraded communication. Known methods for reducing cell site interference involve using a tall antenna tower to point a signal down to the subscriber. A second characteristic of these methods is that a signal beam is generated which is pointed toward the subscriber. The downward angle at which the signal beam is pointed reduces cell site interference. These methods, however, are impractical because they require relatively tall antennas, narrow signal beams and small cell sizes.

### SUMMARY OF THE INVENTION

In accordance with the present invention, a method and system for communicating signals are provided that substantially eliminates or reduces the disadvantages and problems associated with previously developed systems and methods. In general, the present invention reduces interference from nearby cells which utilize the same and nearby frequencies. It substantially reduces interference for any communication system that the radial distance from the basestation to the interferers' locations are defined and approximately known.

According to one embodiment, a system for communicating signals is disclosed that includes two or more antennas, each consisting of two or more antenna elements. All or some of the antennas and antenna elements, optionally, may be physically located within the same structure designated an antenna assembly. For each antenna the second antenna element is spaced apart from the first antenna element in a substantially vertical direction. Additional antenna elements (if used) are likewise spaced from the second antenna element and from one another in a vertical direction. All antenna elements of the antenna operate together to generate an antenna radiation pattern. The phases of each of the antenna elements of an antenna are adjusted and combined in a destructive manner to create a radiation pattern that exhibits a signal reduction at a distance from the antenna which is near the location of interference sources. In this embodiment one or more additional antennas are also created in a manner similar to the first, each also consisting of two or more vertically spaced antenna elements. These antennas may or may not be located within the same physical structure as the first. The phases of each of the antenna elements of the second antenna assembly and subsequent antenna assemblies are likewise adjusted and combined in a destructive manner to create a radiation pattern exhibiting a signal reduction at a distance from the antenna which is near the location of interference. Spacing between the antenna elements in the second antenna and each of the additional antennas (if used) and/or the phases used to create the signal reduction are not the same as those used in the first antenna and are not the same as used in any another antenna. In this manner, each antenna produces radiation pattern characteristics that are unique from the others within a cell while at the same time producing signal reduction for the interference sources. Signal processing selects the antenna radiation pattern with the best received signal quality for each subscriber based on subscriber signal strength and interference weakness.

According to another embodiment, a system for communicating signals is disclosed. The system includes a first subscriber in a first cell and a second subscriber in a second cell. An antenna tower is located in the second cell. The antenna tower selects one of two or more radiation patterns using the same antenna elements or antenna element spacing and signal phasing as described in the first embodiment to provide communication service to the second subscriber while reducing interference for the first subscriber.

A technical advantage of the communication system is that the system reduces cell interference, thus improving the quality of communication. The communication system selects a radiation pattern from two or more patterns in order to communicate with a subscriber and avoid inter-cell interference. The communication system includes two or more antennas, each comprised of two or more vertically spaced apart antenna elements that allow for reduction of interfering signals to/from other cell locations, when the cell locations are defined and approximately known. The communication system may periodically calibrate the antenna radiation patterns by adjusting the phase of the antenna elements in order to avoid cell interference. Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates one embodiment of a communication system incorporating the present invention;

FIG. 2 illustrates a cell site and its associated radiation pattern in the communication system;

FIG. 3 illustrates the cell site and another associated radiation pattern in the communication system;

FIG. 4 illustrates a cell site with an antenna configuration and radiation pattern in the communication system with a subscriber, and another cell site with an interfering subscriber in the communication system;

FIG. 5 illustrates a block diagram of one embodiment of a cell site in the communication system;

FIG. 6 illustrates the phase relationships for the signals from the antenna elements of one embodiment of a cell site;

FIG. 7 illustrates a functional block diagram of the process used for selecting the best radiation pattern of one embodiment of a cell site;

FIG. 8 illustrates the radiation patterns for an antenna of one embodiment of a cell site in the communication system;

FIG. 9 further illustrates the radiation patterns for the antenna of the embodiment of a cell site of FIG. 8 in the communication system;

FIG. 10 illustrates the C/I for one embodiment of a cell site in the communication system;

### DETAILED DESCRIPTION OF THE DRAWINGS

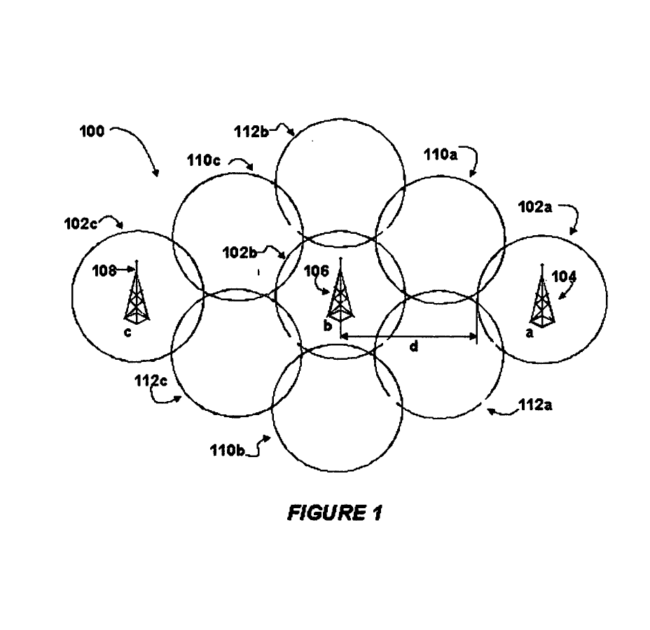

FIG. 1 illustrates one embodiment of a communication system 100 that covers a contiguous area that is broken down into a series of overlapping cell sites, or cells, for example, cell sites 102a-c. According to one embodiment, each cell site 102a-c is surrounded by six adjacent cell sites. Other cell site patterns may be used without departing from the invention.

In this particular embodiment, cell sites 102a-c are approximately the same size, and each cell site 102a-c is approximately circular with a radius r. Each cell site 102a-c has an antenna tower 104, 106, and 108, respectively, located at approximately the center of the cell site. Antenna tower 106 is located at point b of cell site 102b, and antenna tower 108 is located at point c of cell site 102c and antenna tower 104 is located at point a of cell site 102a.

In one embodiment, antenna towers 104, 106, and 108 transmit signals to and receive signals from a subscriber's wireless device, for example, a cell phone, data phone, data device, portable computer, or any other suitable device capable of communicating information over a wireless link. Each antenna tower 104, 106, and 108 is responsible for communicating signals within its own cell site 102a-c, respectively. Each antenna tower 104, 106, and 108 generates a radiation pattern with which a subscriber within the cell site may communicate with the tower. For this particular arrangement of cells, the distance between antenna towers 104 and 106 is approximately 3r, and the distance between antenna towers 104 and 108 is approximately 6r.

The antennas of antenna towers 104, 106, and 108 communicate signals at specific wavelengths or frequencies. Communication system 100 may employ a frequency reuse plan to reduce cell interference. However, if one antenna is too close to another antenna tower operating at the same frequency, cell site interference may result from the interaction of signals from more than one antenna tower and/or cell site, and may result in the degradation of the signals.

In a particular embodiment, antenna tower 104, 106 and 108 may operate at different frequencies than the antenna towers in cells 110a-c and 112a-c to reduce or effectively eliminate interference. The selection and assignment of operating frequencies among the cells in a communications system is defined as a frequency reuse plan. Due to the limited bandwidth available for a frequency reuse plan, antenna towers 104, 106 and 108 may share the same frequencies in communication system 100. Other reuse plan patterns may used without departing from the invention including reuse plans implemented with non-circular cell shapes and with cell sectorization. However, if antenna tower 106 communicates strong signals outside a radius of d, where d is the distance from antenna tower 106 to the closest edge of cell site 102a, cell site interference may result. This cell interference between cell sites operating at similar frequencies may be particularly troublesome for systems in hilly or mountainous terrain, for systems having a limited frequency reuse plan or bandwidth, and for systems employing higher power communications to support greater data communication bandwidth.

In one embodiment, antenna towers 104, 106 and 108 operate with diminished signals at a distance d from the tower. In operation, antenna tower 106 communicates signals to subscribers in cell site 102b by generating an antenna radiation pattern. Antenna tower 106 is required to communicate signals within a radius r, but the signals need to diminish outside of a radius d. If antenna tower 106 communicates strong signals outside of radius d, cell site interference may result between antenna tower 106 and cells 102a and 102c, which operate at the same frequency. To communicate with a subscriber in cell site 102b, antenna tower 106 generates a radiation pattern to reduce interference with cell sites 102a and 102c, thus improving signal communication.

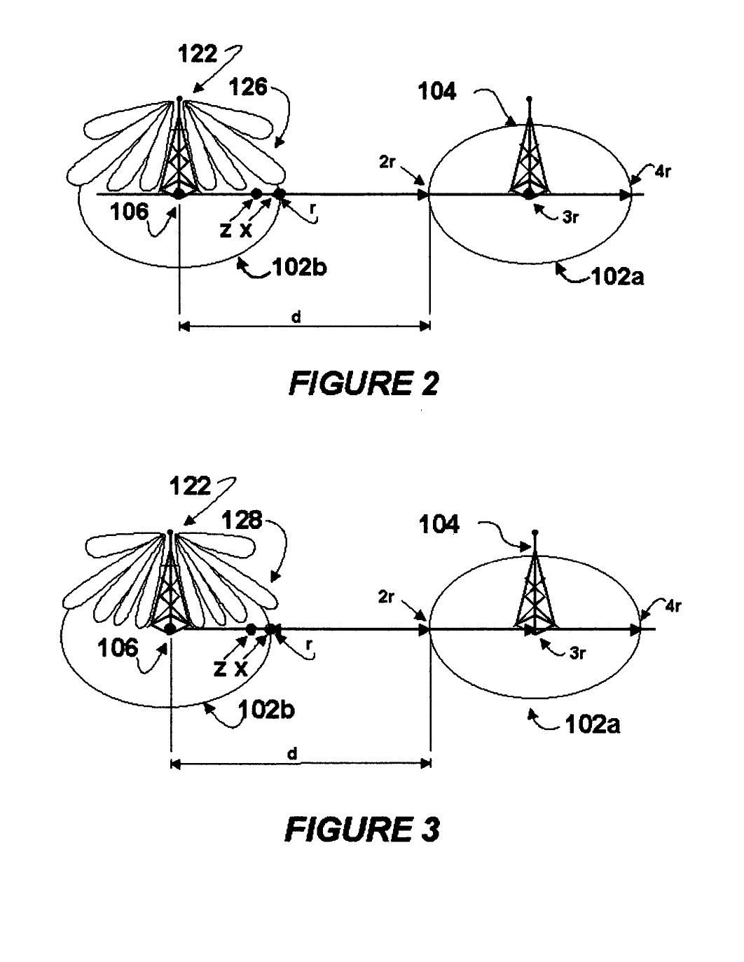

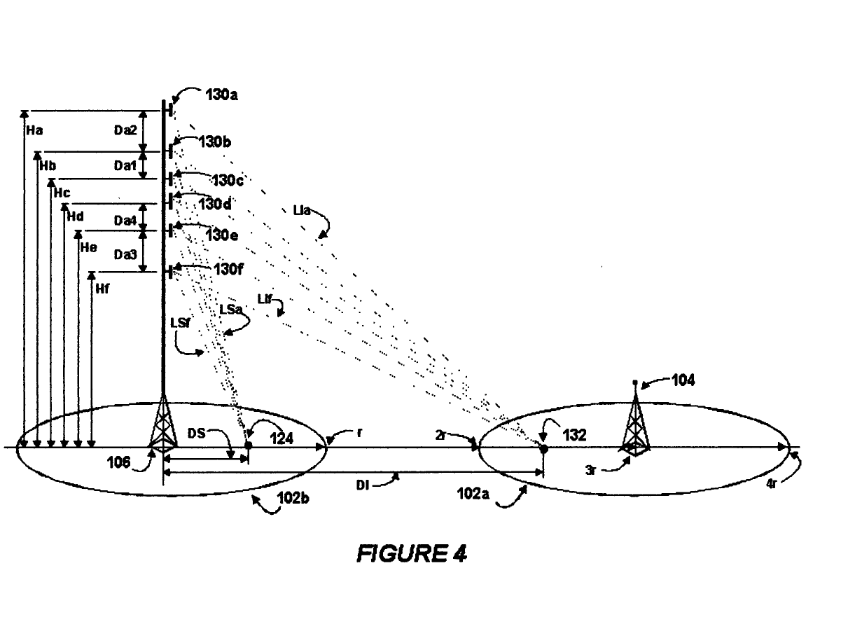

FIG. 2 illustrates a simplified diagram of a cell site 102b and its associated beam pattern 126 for communicating signals. FIG. 2 exaggerates the relative magnitude between the radius r of cell site 102b and the height of antenna tower 106 to illustrate the radiation pattern concept. Antenna tower 106 generates radiation pattern 126 that includes maxima and minima, as represented by the distance to the pattern of FIG. 2 from the point 122 on tower 106. The radiation pattern services a subscriber at point x located at the edge of cell site 102b, approximately at distance r from antenna tower 106. In order to service subscribers in cell site 102b while reducing interference with other cells, radiation pattern 126 may be created that produces a usable antenna gain at point x and reduced gain at a distance d. The maxima of radiation pattern 126 is the decibel measure of the antenna gain, and may be, for example, approximately 23 dB. If point x is offset from the maxima by an amount to cause a reduction of 3 dB, the gain provided at point x in this example would be approximately 20 dB. Nulls are local minima of beam pattern 126, where beam pattern 126 experiences reduced gain. For example, radiation pattern 126 may not be able to service a subscriber located at point z because of a null. Antenna tower 106 may use another radiation pattern to service a subscriber at this location. FIG. 3 illustrates cell site 102b and tower 106 with a radiation pattern 128 which is different from radiation pattern 126. This pattern shows a maximum pointing in the direction z while also presenting a minimum to the nearest point of cell 102a which is at distance d, or approximately 2r. However, radiation pattern 128 exhibits reduced gain at point x at which is at distance r, and is therefore unable to service subscribers at this distance from the tower. It follows that radiation pattern 126 would be more suitable for servicing a subscriber at location x and radiation pattern 128 would be more suitable for servicing a subscriber at location z. A key element in this invention is the generation of two or more radiation patterns, each with a reduced gain at a distance approximately encompassing one or more interference regions, cells 102a and 102c in this case, but with each radiation pattern showing the local maxima and minima in different locations. The communication system selects the best pattern for each subscriber. A procedure for generating the radiation patterns and a process for selecting the best pattern is discussed in more detail in connection with FIGS. 4, 5, 6 and 7.

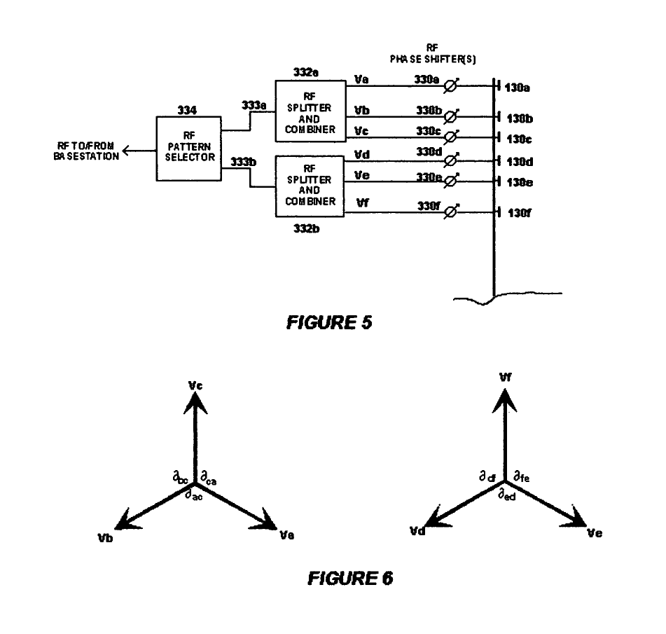

FIG. 4 illustrates one embodiment of a cell site 102b and its associated tower 106 for communicating signals. FIG. 4 exaggerates the relative magnitude between the radius r of cell site 102b and the height of antenna tower 106 to illustrate the radiation pattern generation concept. A subscriber 124 is located within the boundaries of cell 102b at a distance DS. An interferer 132 is located within the boundaries of cell 102a at a distance DI. For this example of this embodiment six antenna elements 130a-f are mounted on the tower at heights above terrain Ha-f. Antenna elements may be dipoles, slots, arrays, horns, sector antennas or any type antenna element suitable for the communication of signals for the subscriber to be serviced. In this embodiment antenna elements 130a-c are configured to generate one radiation pattern and antenna elements 130d-f are configured to generate another radiation pattern. For this purpose, antenna elements 130a-c are vertically spaced above one another by the separations designated as Da1 and Da2, and antenna elements 130d-f are vertically spaced above one another and separated by distances designated Da3 and Da4. The physical relationship between antenna elements 130a-c and antenna elements 130d-f is not specified and not critical for proper operation of this invention. The distance from subscriber 124 to each antenna element is designated by rays LSa-f, respectively and the distance from interferer 132 is designated by rays LIa-f, respectively. As the location of subscriber 124 or interferer 132 changes its radial distance from tower 106 the lengths of the rays LSa-f and LIa-f and the signal phase shifts associated with them change accordingly. The block diagram of FIG. 5 shows one possible implementation of a system to generate the radiation patterns. This implementation uses phase shifters 330a-f to adust the signals associated with antenna elements 130a-f, respectively, to create a minimum gain for each radiation pattern at the desired interference distance. Any implementation of phase shifter technology may be employed including, but not limited to, delay lines, different cable lengths or vector modulators, without deviating from this invention. In this embodiment, the phase shifters 330a-c are adjusted to produce the phase shifts depicted in FIG. 6 when operated in connection with the phase shifts associated with the length of rays LIa-c. As shown in FIG. 6, the resulting three signal vectors Va-c are offset in phase from one another by one-third of a wavelength which is 120 degrees, as represented by angles ∂cb, ∂ba and ∂ac, for signals traveling from the distance of 132 For this embodiment, the second radiation pattern is generated using the phase shifts 330d-f to create the relationships shown in FIG. 6 for signal vectors Vd-f. In general, any combinations of phase differences among signal vectors may be used that cause a reduction of the signal from the interference distance and exhibit different locations for the local minima of each pattern without deviating from this invention. The difference in local minima are required to provide continuous subscriber coverage at all distances from antenna tower 106 within cell 102b. Signal vectors Va-c and Vd-f are combined in the RF Splitters and Combiners, 332a and 332b, respectively, and then applied to an RF Pattern Selector, 334, as shown in FIG. 5. Devices 332a and 332b each combine the signals received by their associated antenna elements for the first embodiment and additionally split the signal to their associated antenna elements for the second embodiment of this invention.

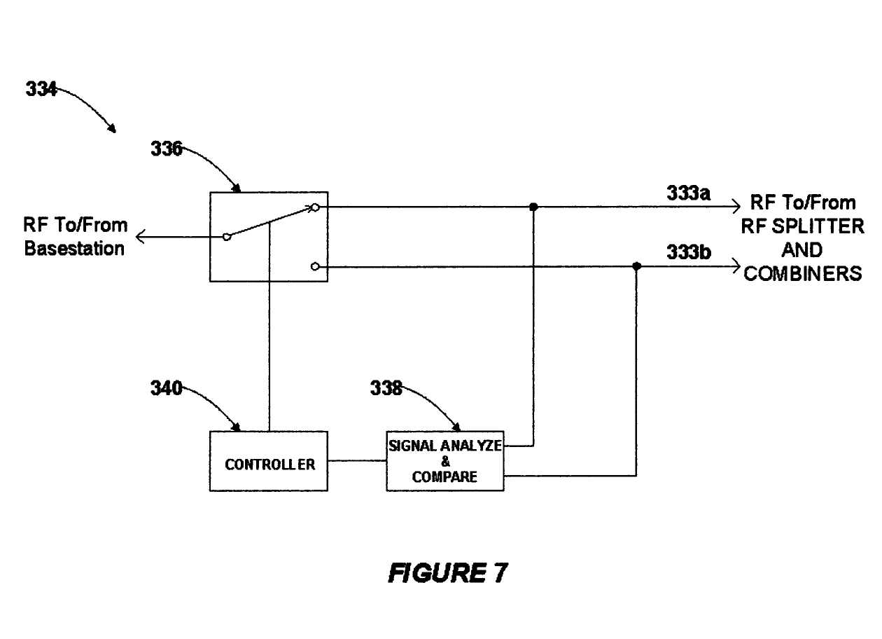

FIG. 7 illustrates one possible implementation of 334, the RF Pattern Selector. For this implementation, The RF Pattern Selector is comprised of three functional elements:

A Signal Analyze and Compare function (block 338), which, in the first embodiment of this invention, receives a sample of the RF from each radiation pattern and measures the signal level and interference level for each and determines which radiation pattern provides an acceptable signal based on signal amplitude and interference amplitude.

A Controller function (block 340), which controls the operation of 334 based on the results of input from 338.

An RF Routing function (block 336), which routes the RF from the radiation pattern providing the acceptable signal to the basestation.

When communicating from the tower (122) to the subscriber (124) in the second embodiment of this invention, the functions performed in 334 provide the connection of the basestation to the same radiation pattern as determined by 334 for communications from the subscriber (124) to the tower (122) in the first embodiment of the invention. The functions of 334 must be performed for each subscriber (124) serviced by the tower (122).

All or some of the functions described for 334 may be contained within the basestation equipment, without deviating from this invention. For the first embodiment of this invention, the RF Routing function (block 336) may be implemented as a weighting and combining process (e.g., Maximal Ratio Combining) instead of selection (switching) as shown, without deviating from this invention.

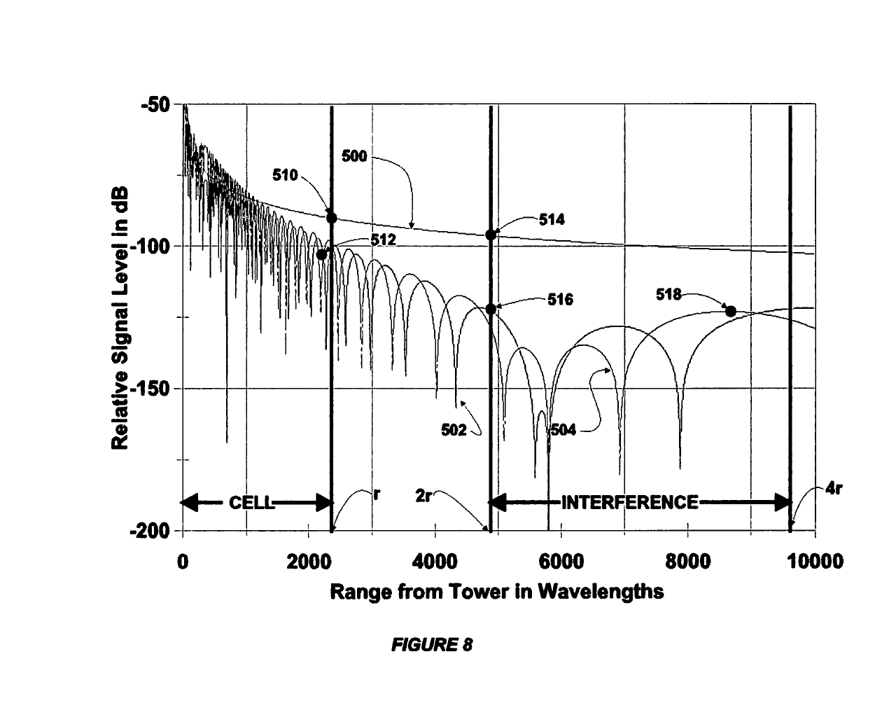

FIG. 8 illustrates in more detail the performance of cell sites 102b and 102a with antenna towers 106 and 104 respectively, that operate at the same frequency. FIG. 8 shows the antenna patterns for three antenna configurations with the following characteristics:

Trace 500 depicts the path loss (relative received level) for an isotropic antenna (equal RF gain in all directions) in free space propagation conditions. Free space propagation conditions are characterized by the fact that the attenuation of a signal will vary according to the square of its distance from the tower. Than is, a signal from a subscriber located at a distance 2r from the tower will be one quarter of the power (minus 6 dB) of the signal at a distance r. Traces 502 and 504 represent the relative antenna RF radiation patterns for one embodiment of a cell site 102b and tower 106, operating under the same free space propagation conditions as trace 500. For the purposes of this example, the following applies:

frequency=901 MHz;

distance r=2400 wavelengths (1 wavelength is approximately 1.092 feet at this frequency;

Cell 102b extends to 2400 wavelengths;

Interfering cell 102a extends from 4800 to 9600 wavelengths;

Referring to FIG. 4, the following dimensions apply for generating radiation pattern 502:

Hc=137 wavelengths

D1=0.641 wavelengths

D2=1.282 wavelengths

Referring to FIG. 4, the following dimensions apply for generating radiation pattern 504:

Hf=137 wavelengths

D3=1.282 wavelengths

D4=0.641 wavelengths

Referring to FIG. 5, the following phase shifts apply for generating radiation pattern 502:

330c=0.000 wavelengths

330b=0.651 wavelengths

330a=0.287 wavelengths

Referring to FIG. 5, the following phase shifts apply for generating radiation pattern 504:

330f=0.000 wavelengths

330e=0.303 wavelengths

330d=0.621 wavelengths

For the example of this embodiment, the relationship of signals Va-f is as shown in FIG. 6 for a distance DI to interferer 132 of approximately 5800 wavelengths. Dimensions Ha-f, D1-4, phase shifts 330a-c, and/or cell 102b and 102a radii may be different without departing from this invention.

FIG. 8 shows one way to compare the relative performance of the isotropic antenna and a communication system using the embodiment of this invention. The ability to communicate signals is commonly represented as the value of Carrier signal level from a subscriber 124, C, to the value of Interference level from interferer 132, I. This is represented by the difference in decibels of the C and I and represented as C/I. From the curve 500 of FIG. 8 we can see that the lowest signal level within cell 102b is approximately −90 dBm at a range of 2400 wavelengths from tower 106 at the point indicated as 510. The highest interference level is approximately −96 dBm for an interferer 132 located at 4800 wavelengths from tower 106 at the point indicated as 514. The worst case C/I for the isotropic antenna is therefore approximately −90 dBm minus −96 dBm or 6 dB. FIG. 8 also shows the interference levels received for traces 502 and 504 for this embodiment of this invention. Point 516 represents the maximum interference level received by the radiation pattern 502 generated using antenna elements 130a-c is −125 dBm at a range of 4800 wavelengths from tower 106. Point 518 represents the maximum interference level received by the radiation pattern 504 generated using antenna elements 130d-f is −125 dBm at a range of 8700 wavelengths from tower 106.

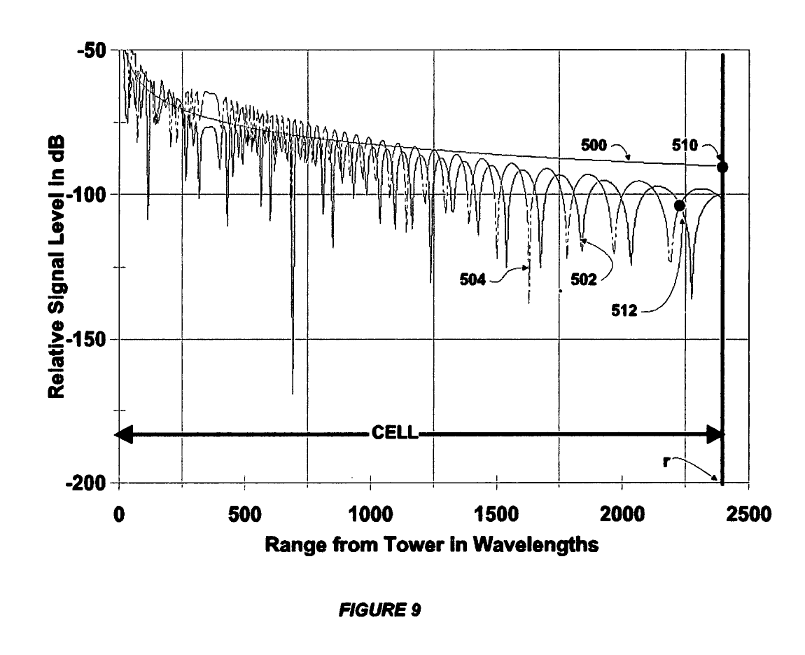

FIG. 9 illustrates the signal levels that will be received within the cell 102b for the three antennas. Point 512 indicates the location of a subscriber that would produce the lowest signal level for patterns 502 and 504 when selection is made of the highest (best) pattern. At point 512, both patterns produce a level of approximately −104 dBm at a distance of approximately 2200 wavelengths from tower 106. For this embodiment both patterns produce approximately the same C/I of −104 dBm minus −125 dBm or 21 dB for subscribers at position 512. Comparing with the 6 dB C/I produced by an isotropic antenna, this embodiment provides approximately 15 dB better C/I than the isotropic antenna at each antenna's worst case location of subscriber and interferer.

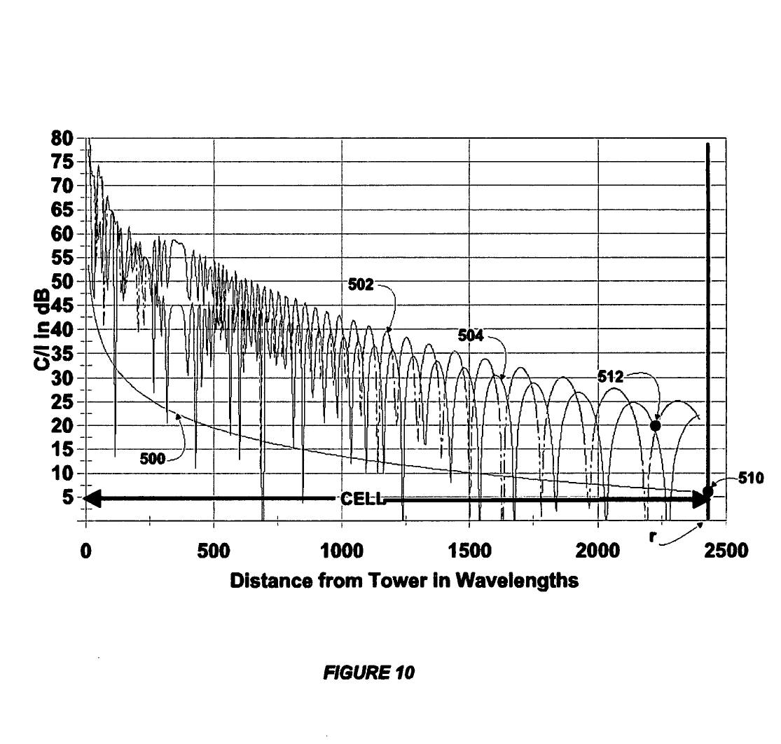

FIG. 10 illustrates the C/I for the isotropic antenna and the two radiation patterns for the embodiment for all subscriber distances from the tower within cell 102b and for the worst case interferer locations in cell 102a. Indicated is the position for the worst case subscriber locations for the isotropic antenna and invention, points 510 and 512 respectively. The worst case C/I is approximately 15 dB better for this embodiment versus the isotropic antenna and on the average is approximately 25 dB. Other embodiments with different antenna element spacing and phasing and different tower height and cell sizes may produce better or worse performance than indicated in FIG. 10.

What is claimed is:

1. A system for communicating signals from subscribers to a basestation, the system comprising a first antenna and one or more additional antennas; and each antenna is comprised of two or more antenna elements spaced apart in a vertical direction from one another, wherein the antenna element may be of any antenna technology suitable for communicating the signals, including but not limited to omnidirectional antennas, dipoles, slotted antennas, horns and arrays.

2. The system of claim 1, wherein the spacing and phasing among the antenna elements of each antenna are selected to create a radiation pattern that produces a signal reduction at a distance where interferers are expected to operate.

3. The system of claim 1 wherein each antenna is constructed with different antenna element spacings and/or phases to produce a radiation pattern for signals within the desired area of coverage that is unique from the other antennas of the system of claim 1, while simultaneously producing the signal reduction for interfering signals addressed in claim 2.

4. The system of claim 1, wherein the RF signal from each antenna is analyzed separately for each subscriber and chosen for reception.

5. The method of claim 4 wherein the signal quality of RF signal from each antenna pattern is measured for each subscriber based on signal level and/or signal to interference level (i.e., C/I.)

6. The method of claim 4 wherein the RF signal from the antenna pattern with the best signal quality for each subscriber as determined in by the method of claim 5 is selected and routed to a basestation receiver. Selection and routing may be via switch selection or by using commonly employed diversity signal combining methods such as Maximal Ratio Combining.

7. A system for communicating signals from subscribers to a basestation, the system comprising a first antenna and one or more additional antennas; and each antenna is comprised of two or more antenna elements spaced apart in a vertical direction from one another, wherein the antenna element may be of any antenna technology suitable for communicating the signals, including but not limited to omnidirectional antennas, dipoles, slotted antennas, horns and arrays.

8. The system of claim 7, wherein the spacing and phasing among the antenna elements of each antenna are selected to create a radiation pattern that produces a signal reduction at a distance where interferers are expected to operate.

9. The system of claim 7, wherein each antenna is constructed with different antenna element spacings and/or phases to produce a radiation pattern for signals within the desired area of coverage that is unique from the other antennas of the system of claim 7, while simultaneously producing the signal reduction for interfering signals addressed in claim 8.

10. The system of claim 7, wherein the RF signal from each antenna is routed to the basestation to be analyzed separately for each subscriber and chosen for reception as determined by methods included in the basestation design.

11. A system for communicating signals between a basestation and subscribers, the system comprising a first antenna and one or more additional antennas; and each antenna is comprised of two or more antenna elements spaced apart in a vertical direction from one another, wherein the antenna element may be of any antenna technology suitable for communicating the signals, including but not limited to omnidirectional antennas, dipoles, slotted antennas, horns and arrays.

12. The system of claim 11, wherein the spacing and phasing among the antenna elements of each antenna are selected to create a radiation pattern that produces a signal reduction at a distance where interferers are expected to operate.

13. The system of claim 11 wherein each antenna is constructed with different antenna element spacings and/or phases to produce a radiation pattern for signals within the desired area of coverage that is unique from the other antennas of the system of claim 11, while simultaneously producing the signal reduction for interfering signals addressed in claim 12.

14. The system of claim 11, wherein the RF signal from each antenna is analyzed separately for each subscriber and chosen for reception.

15. The method of claim 14 wherein the signal quality of RF signal from each antenna pattern is measured for each subscriber based on signal level and/or signal to interference level (i.e., C/I.)

16. The method of claim 14 wherein the RF signal from the antenna pattern with the best signal quality for each subscriber as determined by the method of claim 15 is selected and routed to a basestation receiver. Selection and routing may be via switch selection or by using commonly employed diversity signal combining methods such as Maximal Ratio Combining.

17. The system of claim 11, wherein the antenna selected during the conduct of the method of claim 16 for communications from each subscriber to the basestation is also selected for communicating from the basestation to each subscriber.
